(19) United States
(12) Patent Application Publication
(10) Pub. No.: US 2024/0121350 A1
(43) Pub. Date: Apr. 11, 2024

(54) PROCESSING VIDEO FOR ENHANCED, INTERACTIVE END USER EXPERIENCE

(71) Applicant: Seeen PLLC, EI, CA (US)

(72) Inventors: Todd Carter, New York, NY (US); Andreas Gebhard, Forest Hills, NY (US); Bahjat Safardi, Grenoble (FR); Jacob Coby, Fairview, NC (US); Pawel Mikolajczyk, Houston, TX (US); Taro Koki, Redondo Beach, CA (US)

(21) Appl. No.: 18/554,278

(22) PCT Filed: Apr. 7, 2022
(86) PCT No.: PCT/US2022/023877

§ 371 Date: Oct. 6, 2023

Related U.S. Application Data
(60) Provisional application No. 63/175,841, filed on Apr. 16, 2021.

(30) Foreign Application Priority Data
Apr. 7, 2021 (FR) 2103572

(51) Int. Cl. H04N 5/265; H04N 21/8549; H04N 21/858

(52) U.S. Cl. CPC H04N 5/265; H04N 21/8549; H04N 21/858

(57) ABSTRACT

A video editor is configured to create and edit video content. These configurations provide tools to create shorter segments or video “moments” from longer video content. The tools may permit an end user to embedded information that identifies objects that appear in the short video segments. In one implementation, the video editor can provide interactive tools for the end use to manually create, edit, and “tag” objects in the shorter segment. The video editor may alternatively create a listing of text or transcription. The end user may, in turn, interact with this listing to create the smaller segments of the video content. Once complete, the tools may allow the end user to publish the shorter segments individually or as a collection through their own channels or social media, which may, inter alia, drive consumer views and customer conversion to the identified products and goods.

### CROSS-REFERENCE TO RELATED APPLICATIONS

This application is a § 371 national stage entry of International Application No. PCT/2022/023877, filed on Apr. 7, 2021, and entitled “PROCESSING VIDEO FOR ENHANCED, INTERACTIVE END USER EXPERIENCE,” which claims the benefit of priority to French Ser. No. FR2103572, filed on Apr. 7, 2021, and entitled “PROCESSING VIDEO FOR ENHANCED, INTERACTIVE END USER EXPERIENCE,” and to U.S. Ser. No. 63/175,841, filed on Apr. 16, 2021, and entitled “IMPROVING VIDEO EDITING USING TRANSCRIPTION TEXT.” The content of these applications is incorporated by reference herein in its entirety.

### BACKGROUND

Online content can improve user experience and engagement on individual websites or application software. Digital video is one type of content that has had a profound impact on customer engagement. Investment in ways to enrich video content has led to further customer engagement with the content on myriad of services, including publishing platforms (like YouTube®), curating sites (like Pinterest®), social media networks (like Instagram®), or messaging applications (like WhatsApp®).

### SUMMARY

The subject matter of this disclosure relates to improvements that further enrich video content. Of particular interest are embodiments of an interactive processing, editing, and publishing platform or “tool” for use with digital video content. The embodiments may generate compact, interactive pieces of digital content from larger video files or “raw data.” These video “moments” may include embedded information that identifies and describes (or relates) to objects found in the content. The benefit of the tool herein, however, is that it allows the end user to build the video moments in different ways, from manual instructions from the end user to text transcribed from the raw data file without having to watch or markup the whole video. These features result in significant saving in time or labor.

The tool may include processing components, like software or computer programs, that can make sense of content in the raw data. The content may include visual content (e.g., images in a digital video file) or associated content (e.g., sounds, including speech, that are associated with the visual content in the digital video file). In one implementation, the software may transcribe words and dialogue found in the raw data, for example as pre-processing or post-processing steps to the video production. This feature may create a running list or transcription of the video content. In another implementation, the software may identify objects that appear in the video images or simply by associating the object from words spoken in the video content.

These processes may create individual pieces of processed video (the video moments) that are shorter segments of the raw data based on the appearance of the identified objects, as well. For example, the tool may permit an end user to interact with the transcription to “scroll” through the video file to identify parts (including unbroken speech or whole sentences) of the video file for use in the video moment that are shorter segments of the raw data. The video moment may, in some cases, comprise one or more segmented video subparts where the dialogue found in the transcription exists in the video roll. In another example, the tool may identify an object in the video images, such as a “car,” and create the video moment with a part (e.g., a thirty (30) second segment) that corresponds with the video images where the car appears in the raw data. The tool may further add an interactive tag to the video moment, for example, a dot that will appear on screen during playback of the video moment. Where applicable, the processes may also recognize other features of the “car,” like color, make, and model, and assign that information to the interactive tag. In this way, an end user that views the video moment can scroll over (e.g., with a mouse) or touch the interactive tag to reveal this additional information.

The information may serve a variety of purposes. As noted above, certain information may provide details or context to the tagged object in the processed video. Other information may include a website address (or URL) to purchase the object or other objects (or groups of objects) that includes the tagged object(s). As an added benefit, the information may operate as keywords or other searchable content for use with online search engines. This searchable content may make the processed video more readily searchable and, ultimately, provide better visibility and access to end users that leverage search engines. In one implementation, it may be possible to synthesize or create new video content by extracting and sequencing multiple video moments from a larger subset of digital video files, processed videos, or video moments. The extracted video moments may share relevant identified objects or searchable content that is found in connection with an online search. In one implementation, the new content may include the video moments that include a car of the same make and model.

The tool may also provide a video editor to edit and mange video content. This video editor may provide various tools, including tools to modify video moments, add or move tags, modify tagged information, and the like. These features permit end users to tailor the processed video to their specifications. In one implementation, certain changes by the end user may be fed back into the video processing system as a means to enhance to software functions to better recognize and tag objects in the raw data or create more relevant video moments from raw data.

The tool may also include features to adapt processed video for publication. These features may automatically adapt characteristics, including the format, aspect ratio, compression, and content, of the processed video for optimal use on its designated, target media. As a result, video moments may be optimized individually to best fit display on, for example, YouTube®, Instagram®, or Facebook®.

### DRAWINGS

Reference is now made briefly to the accompanying drawings, in which:

FIG. 1 depicts a schematic diagram for an example of a user interface;

FIG. 2 depicts a screenshot of an example of the user interface of FIG. 1;

FIG. 3 depicts a screenshot of an example of the user interface of FIG. 1;

FIG. 4 depicts a screenshot of an example of the user interface of FIG. 1;

FIG. 5 depicts a screenshot of an example of the user interface of FIG. 1;

FIG. 6 depicts a screenshot of an example of the user interface of FIG. 1;

FIG. 7 depicts a screenshot of an example of the user interface of FIG. 1;

FIG. 8 depicts a screenshot of an example of the user interface of FIG. 1;

FIG. 9 depicts a screenshot of an example of the user interface of FIG. 1; and

FIG. 10 depicts a screenshot of an example of the user interface of FIG. 1;

Where applicable, like reference characters designate identical or corresponding components and units throughout the several views, which are not to scale unless otherwise indicated. The embodiments disclosed herein may include elements that appear in one or more of the several views or in combinations of the several views. Moreover, methods are exemplary only and may be modified by, for example, reordering, adding, removing, and/or altering the individual stages.

The drawings and any description herein use examples to disclose the invention. These examples include the best mode and enable any person skilled in the art to practice the invention, including making and using any devices or systems and performing any incorporated methods. An element or function recited in the singular and proceeded with the word “a” or “an” should be understood as not excluding plural of said elements or functions, unless such exclusion is explicitly recited. References to “one embodiment” or “one implementation” should not be interpreted as excluding the existence of additional embodiments or implementations that also incorporate the recited features.

### DESCRIPTION

The discussion now turns to describe features of the embodiments shown in the drawings noted above. These embodiments provide an end user with a video editing and publication tool. This tool permits end users to customize video content, for example, to segment longer videos into short or abbreviated segments or video “moments” on the basis of certain content found in the videos. This content may include objects or, in some cases, dialogue. The benefit of the proposed design, though, is that these video moments facilitates public interaction with the content. Other embodiments are contemplated within the scope of this disclosure.

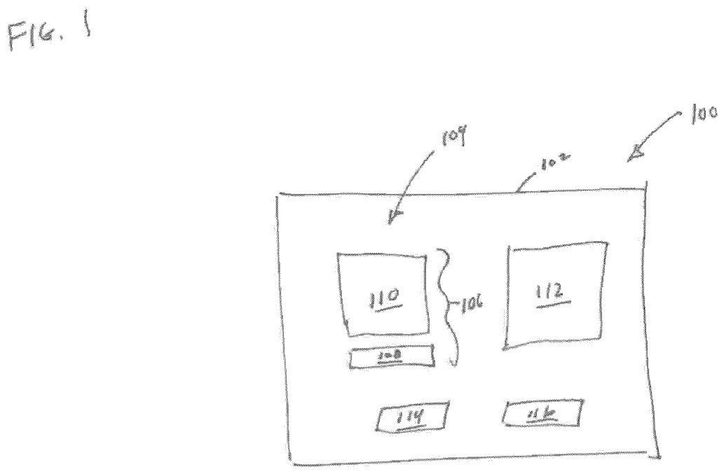

FIG. 1 depicts a schematic diagram for an example of a user interface 100. This example facilitates use of a video editor 102 to create and manage video content. The video editor 102 may include a content area 104 with a player 106. Examples of the player 106 may have a video control icon bar 108 that includes video advance features to control display of content 110, typically digital video content that is the subject of user edits. An editing tool area 112 may provide tools for the end user to leverage, for example, to add or supplement information for the content 110. As also shown, the video editor 102 may include a moment sequence editor 114 and a transcription area 116.

Broadly, the user interface 100 may be configured for the end user to create video moments from their uploaded video content. These video moments may embody short segments or snippets of the longer video. Often, the segment is embedded inside of the longer video content. The smaller size of the video moments afford the end user with easier path to publishing, as well as to provide a more efficient, searchable piece of content that can publish to a website or mobile application, for example, as a “widget.”

The video editor 102 may be configured to be remotely accessible to the end user. Preferably, these configurations resolve on a web browser; however, certain implementations may leverage application software (or “apps”) that reside on a computing device, like a laptop, smartphone, or tablet.

The content area 104 may be configured as a visual display of the digital video content. These configurations may provide the end user with certain tools to view video data. The player 106 may, for example, embody a standard video graphics players. This player may have its own control features, found here in the video control icon bar 108, to manage how the video appears on the visual display. These control features may affect the dynamics of the video (e.g., play, pause, stop, etc.), volume, and size (relative to the end user's computer screen. The content 110 may be configured in various formats, as desired. These formats may include MPR, WMV, WEBM, MOV, AVI, and the like.

The editing tools area 112 may be configured with features to manage information that is associated with the video moments. These configurations may include icons, selectable toggles, text-entry boxes, and the like. The end user can use these features to customize information that may catalog or characterize the content and objects 118 in the video moment, or make the video moment more accessible via search tools.

The moment sequence editor 114 may be configured for the end user to arrange or organize the video moment. These configurations may receive content from the end user. Drag-and-drop technology may prevail for this purpose. In one implementation, this portion of the user interface 100 may form a list of items that can be arranged in various orders, e.g., by moving up or down in the list.

The transcription area 116 may be configured for the end user to interact with text. These configurations may operate as a standalone window in the user interface 100 or as part of the user interface 100 itself. In either case, it may provide a chronological organization of text transcribed from the video content on display on the video graphic player. This feature allows the end user to select from among text, for example, with a mouse or stylus (or finger) on a touch screen. The video graphic player will automatically scroll to the corresponding time in the video content. In one implementation, the end user can flag that part of the video as part of a video moment. Multiple selections of text can be made to flag other time-dependent elements of the video content, also for inclusion in the video moment or as parts of other portions of the video content. These selections may be cataloged in a separate area of the video editor 102, for example, in the moment sequence editor 108. In one implementation, an automated search and extraction feature may permit the end user to search for a keyword or phrase and, in response, the tool may automatically collate parts of the underlying video that contain that keyword or phrase to build the video moment.

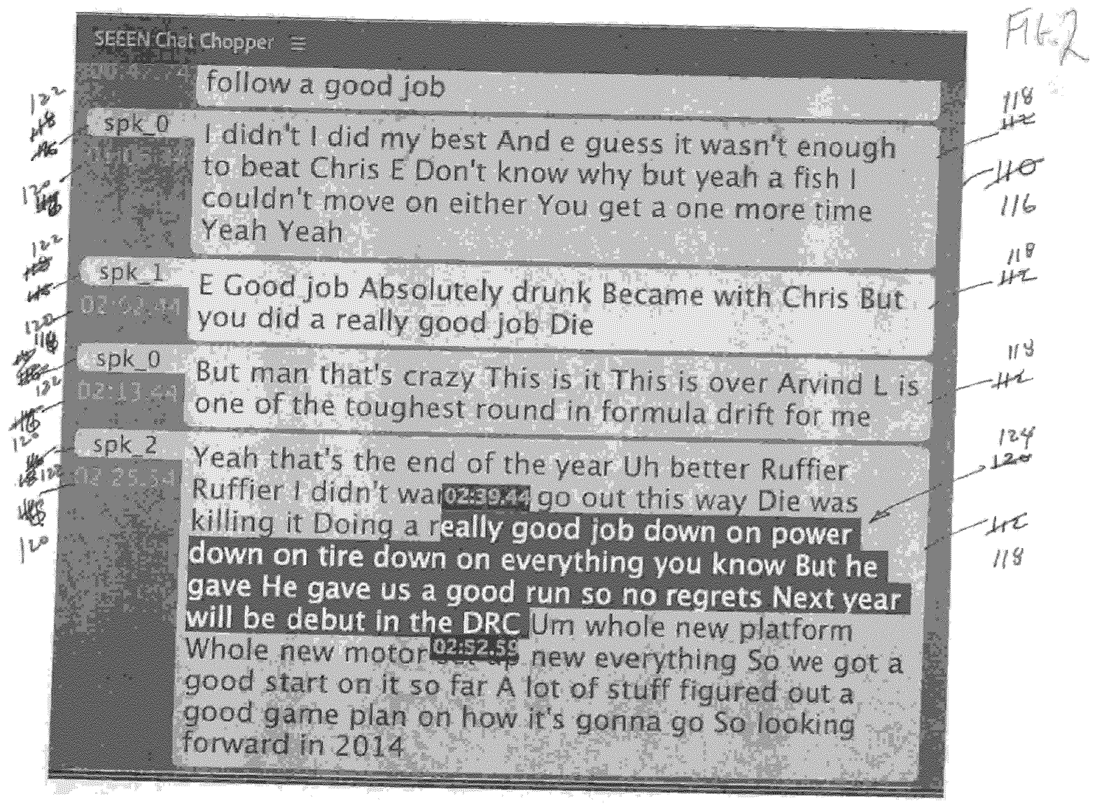

FIG. 2 depicts an example of the transcription area 116. Text 118 may include text content 120, which corresponds with dialogue derived from the video content. A time stamp 120 and speaker identification 122 may help add context to the text content 120 in connection with its corresponding part of the video content. The time stamp 120 may include a precise time in the video content (e.g., minute, seconds) that the dialogue occurs. In one implementation, the transcription area 116 may be equipped with a search feature (or search bar) that permits the end user to search the text 118 of the transcription area 116 by term, time, speaker, etc. This feature can facilitate search and building of the video moment, for example, by foreclosing the need to read the transcription or scroll through the video content. Once an appropriate text 118 is found, the transcription area 116 may allow the end user to select specific text 124, for example, by highlighting the part(s) of the text 118 of interest. The end user may, in turn, move the highlighted portion 124 to the video moment sequence editor 114 (FIG. 1) to become part of the proposed video moment.

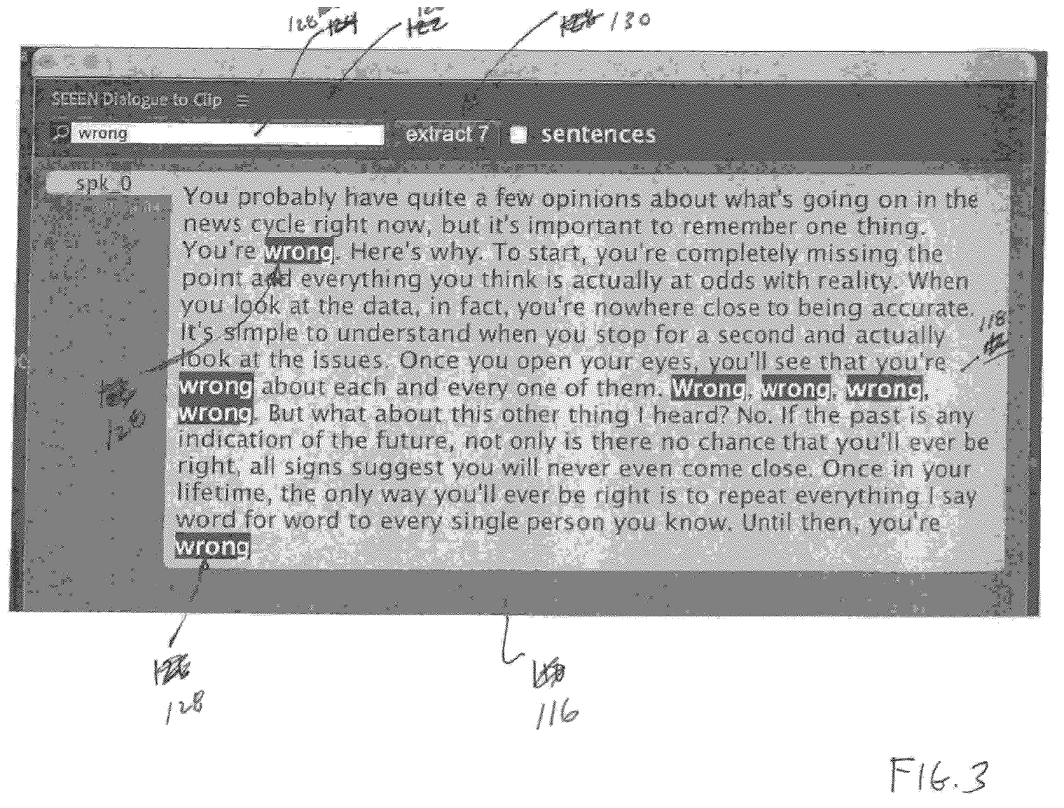

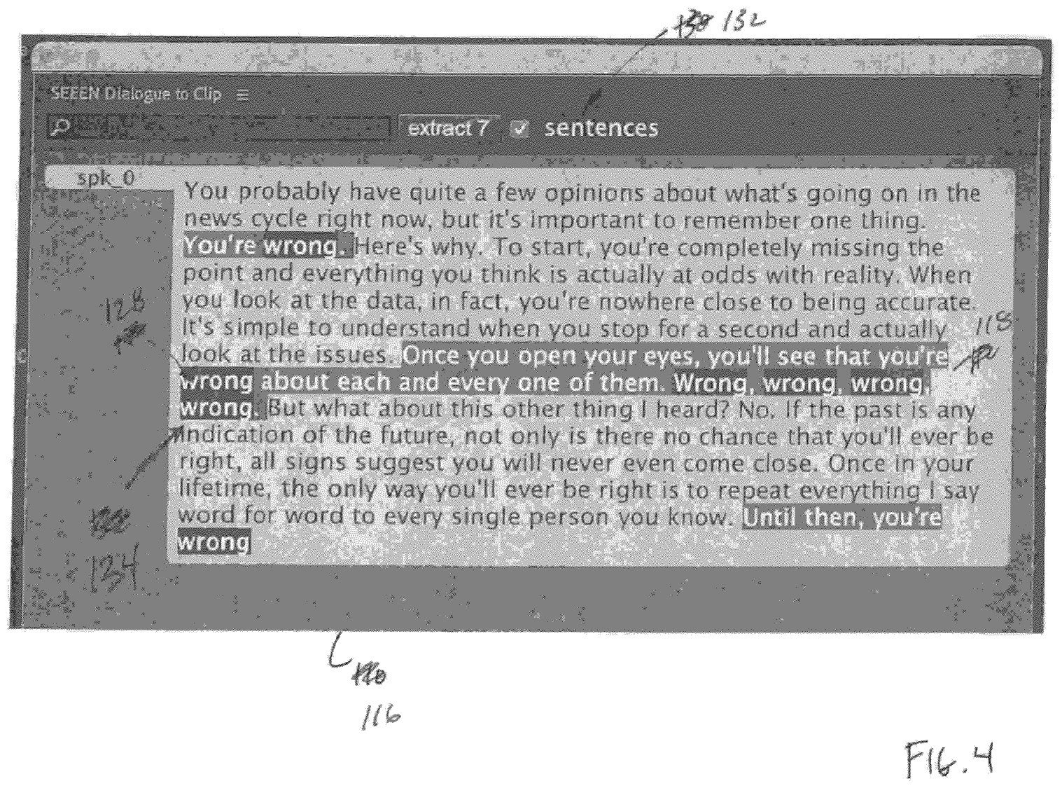

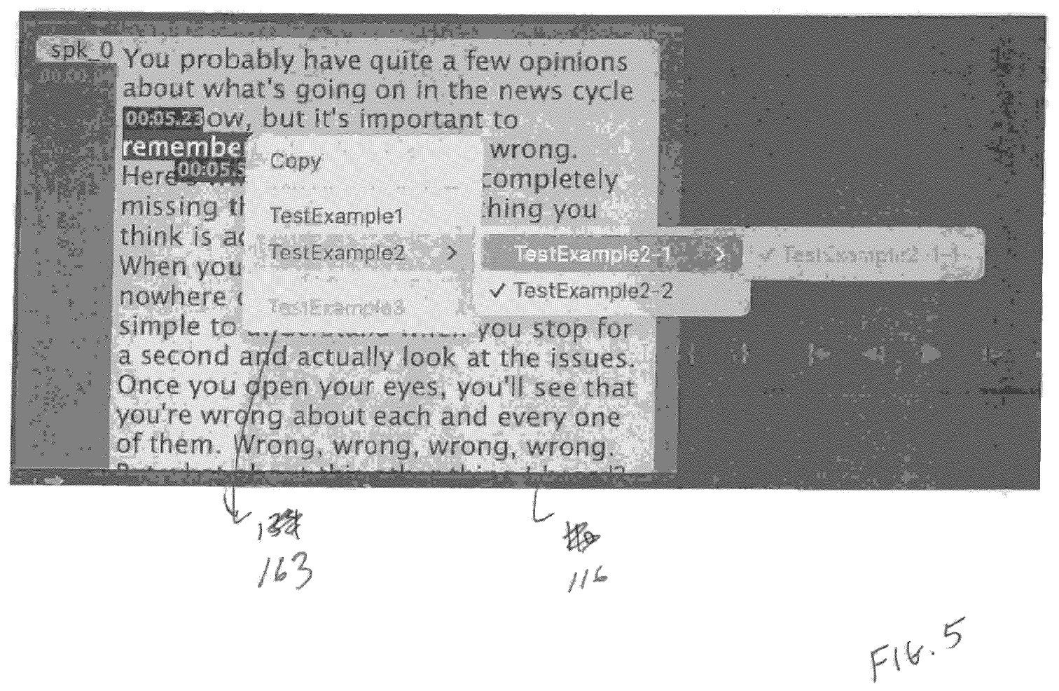

FIGS. 3, 4, and 5 depict examples of the transcription area 116. The example of FIG. 3 includes a search bar 126 with a keyword (or phrase) entry 128. Use of this feature highlights keywords 128 throughout the illustrated text 118. An execute tool 130 permits the end user to provide instructions to collate the parts of the video content that include the keywords 128. This feature may populate the video moment sequence editor 112 (FIG. 1) with parts of the video content that correspond with the text where the keyword is found. In FIG. 4, use of the “sentences” tool 132 highlights the sentence 134 (or, generally, a portion of the text) that incorporates the keyword 128. As best shown in FIG. 5, the transcription area 116 may include menus 136 with certain parameter settings 136. This feature permits an end user to set or optimize operation of the tool to streamline use and enjoyment of the user interface 100.

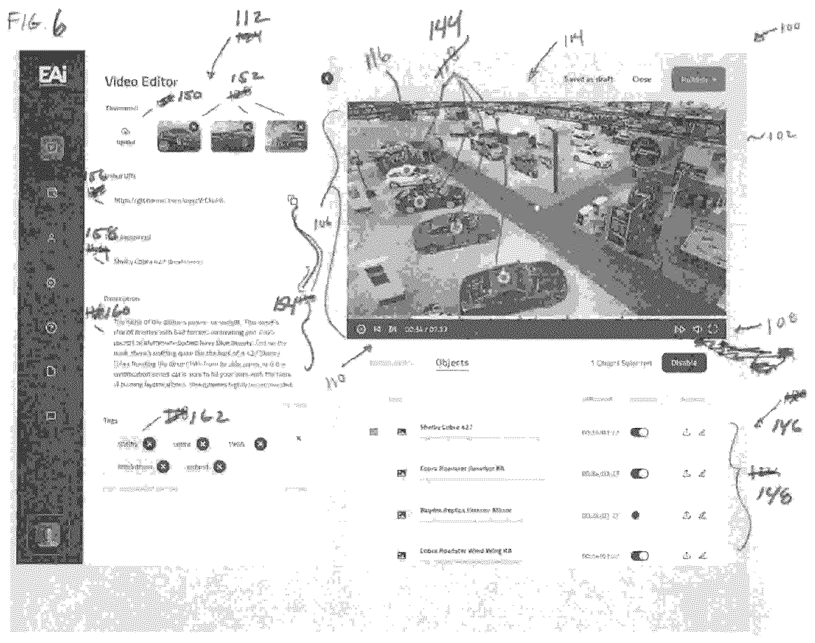

FIG. 6 depicts an example that illustrates structure for the user interface 100. This structure provides a more “manual” toolset 142, one that the end user can use to build the video moments. The toolset 142 may include certain object designators 144, which are pre-populated in separate processing steps, for example, using vision-based software. Examples of this software can identify objects in the video and tag the same with a proper identification, like the make and model of a car. An object area 146 may include a listing 148 of information that corresponds with each of the object designators 144. Pre-processing of the video content 110 may populate the listing 148 in the object area 146. In addition to the text information, the listing 148 may include other information about the object, including defining a segment S (or the video moment) that represents a portion of the content 110 when the object appears in the content 110. The editing tool area 112 may include additional tools for the toolset 142 that the end user can leverage to add or supplement information for the video content 110. Theses tools may allow the end user to upload content 150, as well as to select among previously-uploaded content 152. The end user may use text boxes 154 to assign information to the video content 116, like its published URL 156, its title 158, a description or other text 160, as well as searchable tags 162.

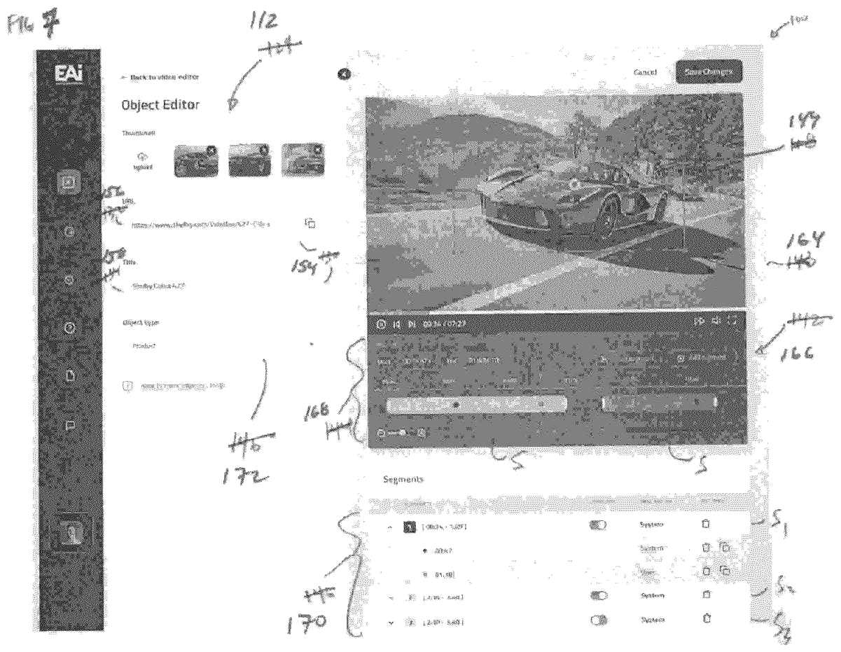

FIG. 7 also depicts exemplary structure for the user interface 100. This structure facilitates use of an object editor 164 that is useful to manage information about the objects (as identified by the object designator 144) in the video content 116. A moment editor 166 may provide various controls 168 for the end user to change the segment S. The controls 168 may allow the end use to change the length of the segment S, whether to shorten or length the segment S, as desired. This feature is useful to the end user because it operates to allow the end user to tailor the segments S. A segment listing 170 may correlate the object designator 144 with various segments S1, S2, S3. This feature identifies segments that include the object designator 118. The end user may select among these particular segments and edit the particular segments. The editing tools area 112 is outfit with facilities for the end user edit information about the objects, including classification or type 172.

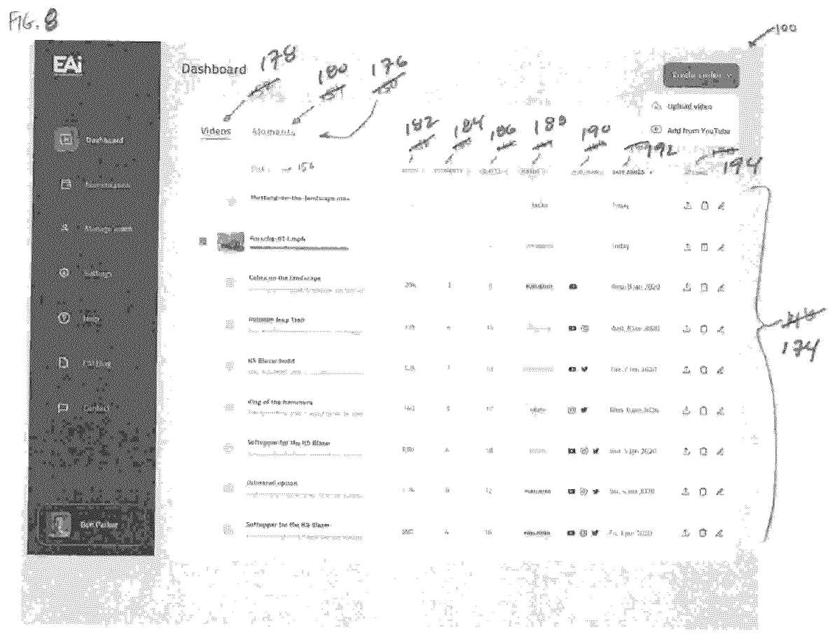

FIG. 8 depicts an example of structure for the user interface 100. This structure provides the end user with a listing 174 of content. User selection icons 176 allow the end user to view content 116 (via a video icon 178) or segments S (via a segment icon 180). The listing 174 includes various information about the video content 116. This information includes the title 180, views 182, video moments 184 found in the content (for videos), object designators 186 (found in the content), status 188, the publishing platform 190, dates 192, as well as various action icons 194. Collectively, this information is useful for purposes of sorting the listing 174 as means, for example, for the end user to find and act on (e.g., edit) particular content. It also provides pertinent data for the end user to analyze the response to published works.

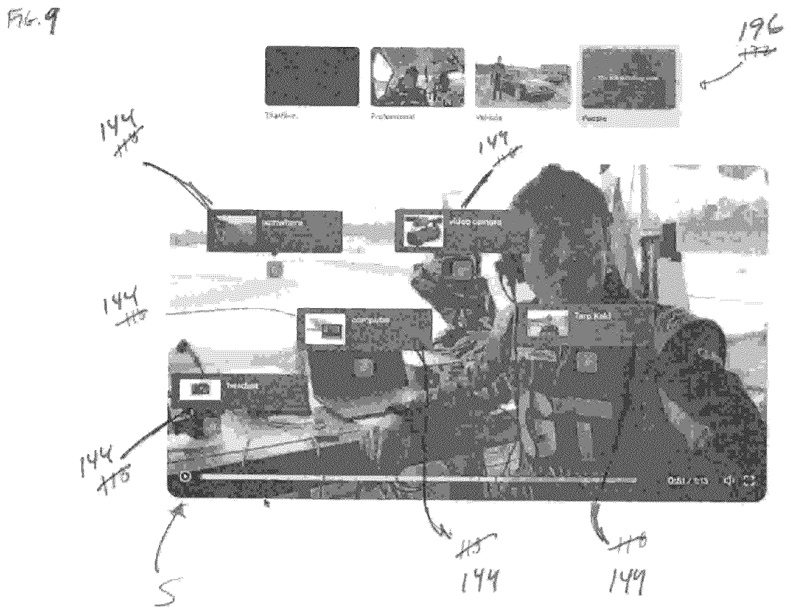

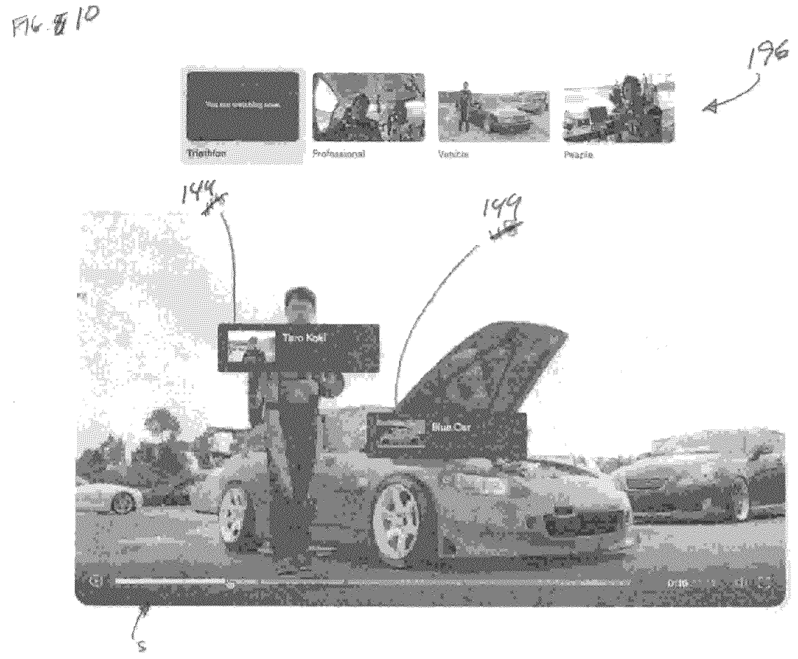

FIGS. 9 and 10 also depict exemplary structure for the user interface 100. This structure displays an exemplary segment S that may result from the video editor 102 (FIG. 1). The tools herein may allow the end user to publish the segment S as a widget 196. This feature makes the video segments S1, S2, S3, S4 much more accessible to view and publish to various third-party platforms (e.g., Instagram®). Each of these segments S1, S2, S3, S4 may have object designators 118 embedded into the video file. The object designators 118 provide the viewer with valuable information about objects that appear in the video moment, whether it is a car, clothing, jewelry, or the like. When published to the third-party platform, the video segment facilitates public interaction with the content by way of mouse-clicks or touch screen. Searchable tags associated with the content or the objects also facilitates search optimization for the content, providing a marketable search advantage.

In view of the foregoing, the improvements herein result in short, compact video files that an end user can publish. These files may have data and information associated with it, including certain identifiers that provide information about products that are visible within the content. The tools to create these files facilitate production. For example, the tools can transcribe dialogue in the video to a listing that an end user can select to efficiently prepare the to-be-published video file.

Examples appear below that include certain elements or clauses one or more of which may be combined with other elements and clauses to describe embodiments contemplated within the scope and spirit of this disclosure. The scope may include and contemplate other examples that occur to those skilled in the art. Such other examples are intended to be within the scope of the claims if they have structural elements that do not differ from the literal language of the claims, or if they include equivalent structural elements with insubstantial differences from the literal language of the claims.

1. A video editor, comprising:
tools to create a shorter segment of larger video file, the shorter segment having a length corresponding to content found in the video file.

2. The video editor of claim 1, wherein the length corresponds to presence of object identifiers embedded in the content and associated with objects that appear in the video content.

3. The video editor of claim 1, wherein the length includes parts of the video file before and after the objects are present on a display.

4. The video editor of claim 1, wherein the length only includes parts of the video file where the object is present on a display.

5. The video editor of claim 1, wherein the length corresponds with certain dialogue in the video file.

6. The video editor of claim 1, further comprising:
tools that provide a transcription of dialogue from the video file, wherein the transcription permits user interaction to select text to assign the length of the shorter segment.

7. The video editor of claim 1, further comprising:
tools that provide a transcription of dialogue from the video file, where the tools include a keyword search to find keywords in the transcription that an end user can interact with to assign the length of the shorter segment.

8. The video editor of claim 1, further comprising:
a transcription of the dialogue from the video file visible on a display, wherein the length of the shorter segment depends on the presence of keywords in the transcription.

9. The video editor of claim 1, further comprising:
a transcription of dialogue from the video file visible on a display, the transcription separated into text according to a speaker in the video content, wherein an end user can interact with the test to assign the length of the shorter segment according to the speaker.

10. The video editor of claim 1, further comprising:
a transcription of dialogue from the video file visible on a display, wherein the end user can drag-and-drop text from the transcription to another area of the display to set the length of the shorter segment.

11. A video editor, comprising:
a content area where video files are displayed;
a transcription area with a listing of text that corresponds with dialogue in the video files on display in the content display area; and
a moment sequence editor operative to receive instances from the listing of text.

12. The video editor of claim 11, further comprising:
a search area to initiate a search of the listing of text for keywords.

13. (canceled)

13. The video editor of claim 11, wherein the listing of text identifies a speaker for the dialogue.

14. The video editor of claim 11, wherein an end user can drag-and-drop a portion of the listing of text into the moment sequence editor.

15. A method, comprising:
creating a transcription from a first video file, the transcription corresponding with dialogue in the video file;
receiving a user input that identifies a selection of the text; and
creating a second video file that includes a portion of the first video file, the portion including the dialogue that corresponds with the selection of the text.

16. The method of claim 15, wherein the first video file is longer than the second video file.

17. The method of claim 15, wherein the user input corresponds with a speaker of the selection of the text.

18. The method of claim 15, wherein the user input corresponds with transfer of the selection of the text from one part of a user interface to another part of the user interface.

19. The method of claim 15, wherein the user input corresponds with a keyword search.

20. The method of claim 15, further comprising:
publishing the second video file as a widget on a third-party publishing platform
